(19) United States
(12) Patent Application Publication
(10) Pub. No.: US 2026/0330807 A1
(43) Pub. Date: Oct. 22, 2026

(54) ACTIVE IN-SITU SENSING METHOD FOR HIGH-VALUE OBJECT ORIENTED TO MOBILE TERMINAL

(71) Applicant: TIANJIN UNIVERSITY, Tianjin (CN)

(72) Inventors: Wei FENG, Tianjin (CN); Qian ZHANG, Tianjin (CN); Liang WAN, Tianjin (CN); Zizhen WANG, Tianjin (CN); Nan LI, Tianjin (CN); Qi ZHANG, Tianjin (CN); Xiaowei WANG, Tianjin (CN); Yipu GONG, Tianjin (CN)

(73) Assignee: TIANJIN UNIVERSITY, Tianjin (CN)

(21) Appl. No.: 19/534,840

(22) Filed: Feb. 10, 2026

(30) Foreign Application Priority Data
Apr. 18, 2025 (CN) 202510490457.3

(51) Int. Cl. G06V 10/77; G06V 10/74; G06V 10/80

(52) U.S. Cl. CPC G06V 10/7715; G06V 10/761; G06V 10/806

(57) ABSTRACT

An active in-situ sensing method for a high-value object oriented to a mobile terminal includes: capturing to obtain image frames in real time according to a reference image; extracting Oriented FAST and Rotated BRIEF (ORB) feature points and feature descriptors from the two image frames for multi-feature fusion matching to obtain reliable matching pairs, and estimating a homography matrix between the two image frames; generating a navigation frame according to the homography matrix, and obtaining a navigation vector therefrom; adjusting a camera pose according to the navigation vector by using a flight instrument mobile terminal; locating the navigation frame through the camera pose, and outputting a sensed image; otherwise, performing key frame update and feature descriptor replacement. According to the present disclosure, in-situ sensing of the camera can be achieved at the mobile terminal, greatly improving robustness, thereby achieving a high-precision and real-time in-situ sensing solution.

### CROSS REFERENCE TO THE RELATED APPLICATIONS

This application is based upon and claims priority to Chinese Patent Application No. 202510490457.3, filed on Apr. 18, 2025, the entire contents of which are incorporated herein by reference.

### TECHNICAL FIELD

The present invention belongs to the technical field of artificial intelligence and computer vision, in particular, to an active in-situ sensing method for a high-value object oriented to a mobile terminal.

### BACKGROUND

A camera is guided to restore its pose at the time of shooting through a single historical image by using active in-situ sensing, physically aligning with a current camera view angle, thereby acquiring key characterization information of an object at its original position. This technology integrates high-precision positioning, camera pose estimation and image processing algorithms, which can effectively reduce errors caused by external interference or view angle deviation in traditional sensing. It is widely applied in fields such as environmental monitoring, cultural heritage protection and micro-change detection, which is an important practical form of an active vision technology.

Existing research is mainly divided into two categories of static and dynamic in-situ sensing. In static in-situ sensing, an image set is searched for a view angle most similar to a reference image based on image feature matching and pose estimation. However, only virtual alignment is performed, resulting in limited positioning accuracy. In dynamic in-situ sensing, the camera physically aligns with a shooting pose of the reference image through a robot platform, achieving millimeter-level precision without relying on hand-eye calibration. A current high-precision method relies on a high-performance motion platform, which is suitable for small-range refined monitoring, but hardly meets the requirements of large-scale inspection or general inspection tasks.

### SUMMARY

The present invention aims to provide an active in-situ sensing method for a high-value object oriented to a mobile terminal. The active in-situ sensing method achieves rapid feature matching through multi-feature fusion matching in combination with a strategy for updating key frames and feature descriptors, and achieves in-situ sensing of a camera through a set visualized navigation frame.

The present invention provides an active in-situ sensing method for a high-value object oriented to a mobile terminal, including the following steps:
capturing to obtain image frames in real time according to a reference image;
extracting Oriented FAST and Rotated BRIEF (ORB) feature points and feature descriptors from two image frames, performing multi-feature fusion matching to obtain reliable matching pairs meeting a projection constraint, and estimating a homography matrix between the two image frames;
generating a navigation frame according to the homography matrix, and obtaining a navigation vector therefrom, where the navigation frame includes a reference frame and a guidance frame;
adjusting a camera pose according to the navigation vector by using the mobile terminal, such that the reference frame overlaps with the guidance frame to form an adjustment object;
locating the navigation frame by adjusting the camera pose, where a visual region meets requirements in a case that the reference frame coincides with the guidance frame as for key frames, such that in-situ sensing is completed; and
outputting an in-situ sensed image.

In some implementations, the navigation vector further includes a navigation direction, including left-and-right motion, up-and-down motion, front-and-back motion, left-and-right rotation, up-and-down rotation, and clockwise-and-anticlockwise rotation.

In some implementations, the step of performing multi-feature fusion matching on the two image frames to obtain the reliable matching pairs meeting the projection constraint further includes: as for the ORB feature points and descriptors extracted from a current frame of image, extracting key points and binary descriptors of the two images by using an ORB algorithm in parallel, performing initial matching through a Hamming distance, estimating the homography matrix between the two images through a Random Sample Consensus (RANSAC) algorithm, eliminating geometrically-inconsistent mismatching points, and finally reserving the reliable matching pairs meeting the projection constraint.

In some implementations, the step of locating the navigation frame by adjusting the camera pose further includes: adding a current frame to a key frame set in a case that a current moment exists more than 5 consecutive frames and a distance between each frame and a best key frame is greater than 15 pixels, or the number of matching points for the current frame exceeds a threshold.

In some implementations, the step of locating the navigation frame by adjusting the camera pose, where the visual region meets requirements in a case that the reference frame overlaps with the guidance frame as for the key frames, such that in-situ sensing is completed further includes: performing key frame update and feature descriptor replacement.

In some implementations, the step of performing key frame update further includes a key frame update strategy, after generating corresponding navigation information for the current frame, determining whether the current frame is robust enough to become a new key frame, and updating the best key frame and a worst key frame.

In some implementations, the step of performing feature descriptor replacement further includes: if a feature point f_{ref}=(p_{ref}, d_{ref}) at a historical reference moment is matched five or more times, adopting a feature of the corresponding feature point in the current image as a candidate replacement descriptor d_{cur}; if after an image is added to the key frame set, a feature point is successfully matched to the image feature and becomes an interior point in the key set, replacing a descriptor at the reference moment with the candidate replacement descriptor, that is, r_{ref}=(p_{ref}, d_{cur}), and skipping to multi-feature fusion matching; where f_{ref} represents the feature point of the reference image, p_{ref} represents coordinates of the feature point of the reference image, d_{ref} represents the feature descriptor of the reference image, and r_{ref} represents the coordinates of the feature point of the replaced image.

In some implementations, the navigation vector allows for visual representation of the navigation information.

Compared with the prior art, the present invention can achieve the following beneficial technical effects:

1) multi-feature fusion matching is performed to obtain the reliable matching pairs meeting the projection constraint, and the homography matrix between the two image frames is estimated; the navigation frame is generated according to the homography matrix, and the navigation vector is obtained therefrom; the navigation frame includes the reference frame and the guidance frame; and in-situ sensing of the camera can be achieved at the mobile terminal, and rapid and convenient in-situ sensing of the camera pose is achieved in a man-machine interaction manner, thereby greatly improving robustness and meeting the requirements of the in-situ sensing solution for high precision and real-time performance.

2) In combination with feature key frame update and feature descriptor replacement, operation space is saved, achieving reduced operation space, easy deployment and reducing operating costs.

### BRIEF DESCRIPTION OF THE DRAWINGS

FIG. 1 is a flowchart of an active in-situ sensing method for a high-value object oriented to a mobile terminal according to the present invention;

FIG. 2 is a technical route diagram of an active in-situ sensing method for a high-value object oriented to a mobile terminal according to the present invention; and

FIG. 3 is a diagram showing an active sensing result in a 3D scenario.

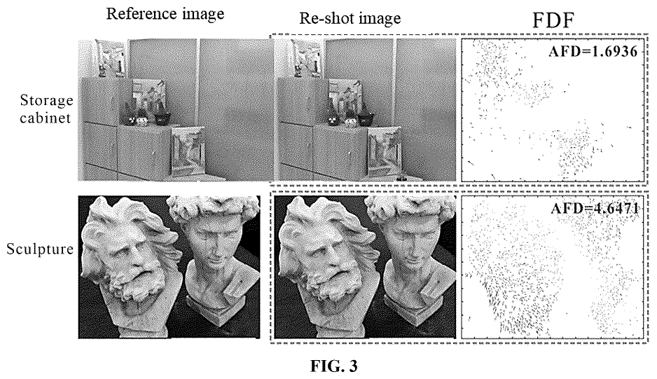

### DETAILED DESCRIPTION OF THE EMBODIMENTS

The technical solution of the present invention will be clearly and completely described below with reference to accompanying drawings. All other embodiments obtained by those ordinarily skilled in the art without involving inventive efforts based on the technical solution in the present invention fall within the scope of protection of the present invention.

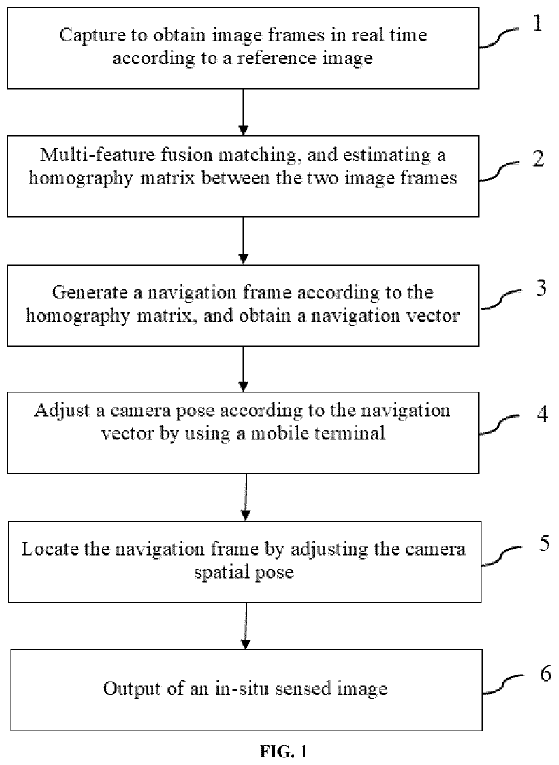

As shown in FIG. 1, FIG. 1 shows an overall flow of an active in-situ sensing method for a high-value object oriented to a mobile terminal according to the present invention. The flow specifically includes the following steps:
step 1: initialization: a historical reference image Ire is given, and a current frame of image I_{cur} is captured and obtained in real time according to the reference image I_{ref};
step 2: multi-feature fusion matching: ORB feature points and descriptors p_{ck} are extracted from the current frame of image I_{cur}, key points and binary descriptors of the two images are extracted by using an ORB algorithm in parallel, and initial matching is performed through a Hamming distance; a homography matrix between the two images is estimated through an RANSAC algorithm, geometrically-inconsistent mismatching points are eliminated, and reliable matching pairs meeting a projection constraint are finally reserved;
step 3: generation of navigation information: a navigation frame is generated according to the homography matrix H_{cr}, the navigation frame including a reference frame [symbol] and a guidance frame [symbol] ᵣ, and then a navigation vector v=[v₁, . . . , v₆] is obtained therefrom; v₁ represents left-and-right motion, v₂ represents up-and-down motion, v₃ represents front-and-back motion, v₄ represents left-and-right rotation, v₅ represents up-and-down rotation, v₆ represents clockwise-and-anticlockwise rotation, that is, each navigation vector further includes a navigation direction, the navigation information is visualized according to the navigation vector based on flight instruments, and each navigation vector further includes the navigation direction;
step 4: adjustment of a camera pose: the reference frame overlaps with the guidance frame as much as possible according to the navigation vector and a flight instrument mobile terminal device;
step 5: the navigation frame is located by adjusting the camera pose, a visual region meets requirements in a case that the reference frame overlaps with the guidance frame, in-situ sensing is completed, and it skips to step 6; otherwise, if there exist more than 5 consecutive frames at a current moment, and a distance between each frame and a best key frame is greater than 15 pixels (a current view angle greatly differs from a key frame view angle) or the number of matching points for the current frame exceeds a threshold, perform a key frame update strategy and a feature descriptor replacement strategy, that is to add the current frame to the key frame set; a score sᵢ of each key frame Kᵢ is calculated at the end of each frame, and a worst key frame K_{worst} with a lowest score is proposed in a case that the key frame set includes more than 20 frames; in a case that a feature point f_{ref}=(p_{ref}, d_{ref}) at a historical reference moment is matched five or more times, a feature d_{cur} of the corresponding feature point in the current image is adopted as a candidate replacement descriptor, in a case that after an image is added to the key frame set, a feature point is successfully matched to the feature point and becomes an interior point, a descriptor at the reference moment is replaced with the candidate replacement descriptor, that is, r_{ref}=(p_{ref}, d_{cur}), and it skips to step 2; and
step 6: a sensed image is output: the current frame of image I_{cur} is output as a currently sensed image.

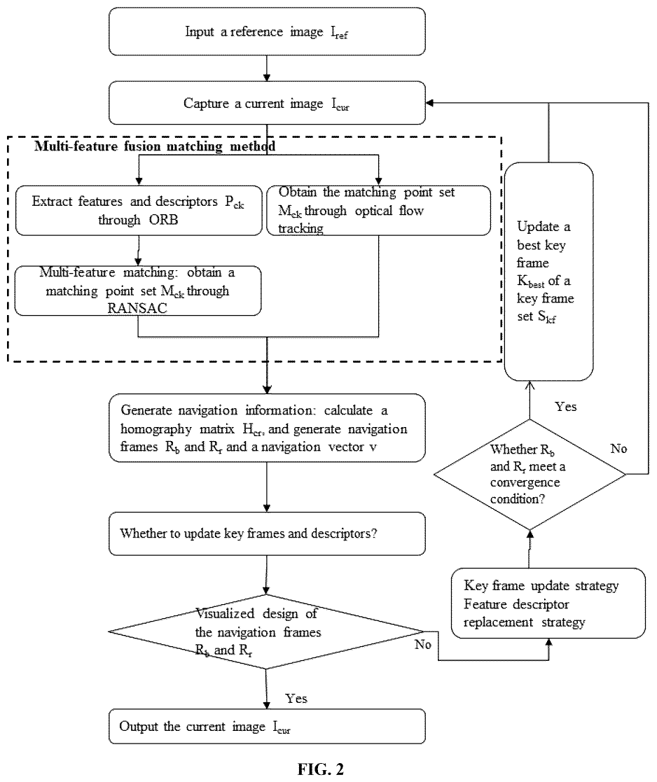

As shown in FIG. 2, FIG. 2 is a technical route diagram of an active in-situ sensing method for a high-value object oriented to a mobile terminal.

Specifically, performing multi-feature fusion matching in step 2 specifically includes the following process:
in order to further accelerate matching, in a case that ORB feature extraction and RANSAC reliable matching are adopted for a latest image, an optical flow method is switched to track feature points matched with a previous image for the following several frames of images. That is, in a case that ORB feature point matching is adopted for a to-be-processed latest frame of image, the optical flow method is switched to track the feature points matched with the previous frame of image for the following several frames of images; in a case that one of the following conditions occurs: (1) more than 20 consecutive frames, (2) less than 30 tracked feature points, (3) more than 5% of feature points are lost in optical flow tracking, and (4) a matching point motion distance exceeds 5 pixels, reliable feature matching based on the RANSAC algorithm is switched.

The calculation complexity of the optical flow method only requires 0 (mn), where n=10, represents a size of a calculation window and m represents the number of tracking points. Tracking can be completed only in 40-70 ms on a mobile terminal. The tracked points are matching points at the current moment. In addition, the optical flow method is relatively reliable since displacement between adjacent frames in image flow is small and an assumption of gravel level invariance is met.

The optical flow method as described above is only limited to tracking points between the adjacent frames with small displacement, and error accumulation is likely to be caused in a case that the optical flow method is adopted for tracking matching points, leading to decrease in precision of the homography matrix. Thus, a switch to reliable matching based on RANSAC will occur in any of the following conditions:
i. as for avoiding larger error accumulation: the optical flow method has been adopted for matching for more than 20 consecutive frames.
ii. fewer common viewpoints: tracked feature points are fewer than 30.
iii. more point loss: more than 5% of feature points are lost in the optical flow method.
iv. larger motion: a motion distance of points in a current frame and a last frame adopting RANSAC matching exceeds 5 pixels.

Furthermore, in step 2, an improved ORB feature matching method is adopted for reliable matching of ORB features, which is analyzed as follows:
although features such as SIFT and SURF are more robust to illumination and view angle changes, calculation rates thereof at the mobile terminal are too low (>10 s). ORB feature points are adopted in the present invention. It takes about (150-200 ms) for this feature to extract 1,000 feature points from an image at 640×480, such that features still cannot be extracted in real time. Moreover, feature description precision will be affected by too small images, and the strategy for ORB feature extraction and descriptor calculation in parallel is proposed in order to accelerate feature extraction and descriptor calculation, that is, a captured current frame of image is divided into t_{thread} blocks, equivalently, each thread is responsible for extracting feature points of a

$$\frac{1}{{t}_{t h r e a d}}$$

image size, all the feature points are evenly divided into t_{thread} parts after ORB feature points are extracted, and descriptors are calculated by various threads. In another aspect, a method for evenly extracting ORB features is adopted in order to further improve the effectiveness of ORB feature points. During feature point matching, most similar matching points are searched through Kd-tree, and then outer points are eliminated through RANSAC. Since the number of iterations of RANSAC is positively related to the proportion of interior points, some unreasonable matching points are firstly eliminated through ratio testing or other methods before RANSAC in order to prevent too large number of iterations.

Specifically, generating the navigation information in step 3 specifically includes the following process:
the homography matrix H_{cr} is calculated according to matching points for calculation and generation of the navigation frame and the navigation vector, the navigation frame including the blue reference frame [symbol] and the red guidance frame [symbol] , and then the navigation vector v=[v₁, . . . , v₆] is obtained therefrom; and the navigation frame and the navigation vector are used for guiding a user to move. The navigation frame includes the blue reference frame [symbol] and the red guidance frame [symbol] , and the reference frame is defined in the following formula:

$${ℛ}_{b} = \{ {p}_{1}^{b} , {p}_{2}^{b} , {p}_{3}^{b} , {p}_{4}^{b} , {c}_{1}^{b} , {c}_{2}^{b} , {c}_{3}^{b} , {c}_{4}^{b} \} \qquad ( 1 )$$

where

$${p}_{1}^{b} = [ \frac{w}{6} , \frac{h}{6} ] , {p}_{2}^{b} = [ \frac{5 w}{6} , \frac{h}{6} ] , {p}_{3}^{b} = [ \frac{5 w}{6} , \frac{5 h}{6} ] , {p}_{4}^{b} = [ \frac{w}{6} , \frac{5 h}{6} ]$$

represents four vertexes of a rectangle of the blue navigation frame,

$${c}_{1}^{b} = [ \frac{w}{3} , \frac{h}{2} ] , {c}_{2}^{b} = [ \frac{2 w}{3} , \frac{h}{2} ]$$

and

$${c}_{3}^{b} = [ \frac{w}{2} , \frac{h}{3} ] , {c}_{4}^{b} = [ \frac{w}{2} , \frac{2 h}{3} ]$$

form a cross line position intersecting at a center the rectangle, and w and h respectively represent a width and height of an image.

The navigation frame [symbol] is calculated through the homography matrix H_{cr} and the reference frame.

$${ℛ}_{r} = \{ {p}_{1}^{r} , {p}_{2}^{r} , {p}_{3}^{r} , {p}_{4}^{r} , {c}_{1}^{r} , {c}_{2}^{r} , {c}_{3}^{r} , {c}_{4}^{r} \} \qquad ( 2 )$$

$${p}_{1 , 2 , 3 , 4}^{r} = {H}_{cr} {p}_{1 , 2 , 3 , 4}^{b} , {c}_{i 1 , 2 , 3 , 4}^{r} = {H}_{cr}$$

The active sensing process aims to make the navigation frame overlaps with the reference frame, that is, H_{cr}=I, where I is a unit matrix (a unit matrix in an order the same as that of the homography matrix).

The navigation frame is formed by coupling six freedom degrees, the navigation vector with definite information representing a motion direction is generated for judgment, and a specific criterion for generating the navigation vector is summarized by observing the performance of the navigation frame, as shown in Formula (3).

$$\{ \begin{matrix}{o}_{1} = \sum ( {P}_{i , x}^{r} ) - \sum ( {P}_{i , x}^{b} ) , {v}_{1} = \{ \begin{matrix}1 , {o}_{1} > {τ}_{1} move right \\ - 1 , {o}_{1} < - {τ}_{1} move left \\ 0 , {o}_{1} ∈ [ - {τ}_{1} , {τ}_{1} ] complete\end{matrix} \\ {o}_{2} = \sum ( {P}_{i , x}^{r} ) - \sum ( {P}_{i , x}^{b} ) , {v}_{2} = \{ \begin{matrix}1 , {o}_{2} > {τ}_{2} move down \\ - 1 , {o}_{2} < - {τ}_{2} move up \\ 0 , {o}_{2} ∈ [ - {τ}_{2} , {τ}_{2} ] complete\end{matrix} \\ {o}_{3} = Area ( {R}_{r} ) - Area ( {R}_{b} ) , {v}_{3} = \{ \begin{matrix}1 , {o}_{3} > {τ}_{3} move back \\ - 1 , {o}_{3} < - {τ}_{3} move forward \\ 0 , {o}_{3} ∈ [ - {τ}_{3} , {τ}_{3} ] complete\end{matrix} \\ {o}_{4} = ‖ {p}_{1}^{r} - {p}_{4}^{r} ‖ - ‖ {p}_{2}^{r} - {p}_{2}^{r} ‖ , {v}_{4} = \{ \begin{matrix}1 , {o}_{4} > {τ}_{4} rotate to right \\ - 1 , {o}_{4} < - {τ}_{4} rotate to left \\ 0 , {o}_{4} ∈ [ - {τ}_{4} , {τ}_{4} ] complete\end{matrix} \\ {o}_{5} = ‖ {p}_{1}^{r} - {p}_{2}^{r} ‖ - ‖ {p}_{3}^{r} - {p}_{4}^{r} ‖ , {v}_{5} = \{ \begin{matrix}1 , {o}_{5} > {τ}_{5} rotate down \\ - 1 , {o}_{5} < - {τ}_{5} rotate up \\ 0 , {o}_{5} ∈ [ - {τ}_{5} , {τ}_{5} ] complete\end{matrix} \\ {o}_{6} = ‖ {p}_{1}^{r} - {p}_{2}^{r} ‖ - ‖ {p}_{3}^{r} - {p}_{4}^{r} ‖ , {v}_{6} = \{ \begin{matrix}1 , {o}_{6} > {τ}_{6} rotate down \\ - 1 , {o}_{6} < - {τ}_{6} rotate up \\ 0 , {o}_{6} ∈ [ - {τ}_{6} , {τ}_{6} ] complete\end{matrix}\end{matrix} \qquad ( 3 )$$

where o₁, o₂, o₃, o₄, o₅, and o₆ represent offsets of different elements of a rectangular frame, which are used for judging the navigation vector v=[v₁, . . . , v₆], and τ₁, τ₂, τ₃, τ₄, and τ₅ represent thresholds for judgment. For each navigation vector herein, three values −1, 0, −1 are respectively provided, representing a motion direction of translation or rotation. In a case of v=0, the in-situ sensing process is completed, and the camera will automatically shoot a completed image at this time.

Furthermore, the present invention further supports the visualization of the navigation information.

In order to improve the visuality of the navigation information and the user operability, a navigation interface based on a flight instrument panel style is introduced in this method, achieving visualized expression of the motion navigation information of the camera. It specifically includes: pitch angle change is displayed through a middle white line and a numerical value; a red pointer of a dial indicates a rotation direction in plane; a width ratio of left and right sides of the red navigation frame indicates left-and-right rotation; an offset of a center of the red frame relative to a center of the blue reference frame reflects up-and-down and left-and-right translation directions; and area change of the red frame is used for indicating a front-and-back motion distance. Compared with a traditional navigation vector or rectangle guidance method, this design is more visual and easier to understand, thereby significantly reducing the operation threshold of the user, which is suitable for rapid learning and accurate positioning operation by non-professional users.

Specifically, key frame decision making in step 5 specifically includes the following processing:
a key frame set [symbol] is maintained in the in-situ sensing process, the set includes a best key frame K_{best} and a worst key frame K_{worst}. Since image information needs to be saved for each key frame for matching and a cellphone memory is limited, the key frame set may not be too large, and the key frame set [symbol] is limited to include 20 frames to the maximum degree in this method. Prior to the in-situ sensing process, an initial key frame set [symbol] only includes the historical reference image I_{ref}. Feature points of each current frame will be matched with feature points of the best key frame K_{best}. After corresponding navigation information is generated for the current frame, whether the current frame is robust enough to become a new key frame is determined, and the best key frame and the worst key frame are correspondingly updated.

In a case that the current frame meets all the following conditions: 1) a current moment exist more than 5 consecutive frames and a distance between each frame and a best key frame is greater than 15 pixels, and 2) the number of matching points exceed a threshold, the current frame, as a key frame, is inserted into the key frame set (a current view angle greatly differs from a key frame view angle).

The distance is defined in the following formula:

$$D ( {F}_{cur} , {K}_{b e s t} ) = \frac{1}{8} {‖ {ℛ}_{cur}^{r} - {ℛ}_{kf}^{r} ‖}_{2}^{2} \qquad ( 4 )$$

where [symbol] and [symbol] represent navigation frames corresponding to the current frame and the best key frame. If the key frame set includes more than 20 frames, the worst key frame will be eliminated.

A score sᵢ of each key frame Kᵢ is calculated at the end of each frame, the score mainly representing the number of the matching points and the closeness to the current frame, which is defined as follows:

sᵢ=αmᵢ+(1−α)max{0,100−D(F_{cur}, Kᵢ)} (5)
where mᵢ represents the number of matching points with the reference frame, α represents a parameter, and key frames with highest and lowest scores are respectively updated as a best key frame K_{best} and a worst key frame K_{worst}.

The homography matrix is calculated by using the current frame and the reference image. On the basis of a group of matching points (p_{cur}, q_{kf})∈M_{ck} between the current frame and the key frame, the matching points w_{ref} in the reference image can be found through the homography matrix Hₖᵣ between the key frame and the reference frame by using q_{kf}, p_{cur} represents coordinates of a feature point of the current image, q_{kf} is a feature descriptor, M_{ck} is a matching point set between the current frame and the key frame, and w_{ref} is feature information between the reference frame and the key frame. This pair of matching points (p_{cur}, w_{ref}) are put into M_{cr}, and w_{ref} is defined in the following formula:

$${w}_{ref} = \{ \begin{matrix}{w}_{ref} & ∃ {w}_{ref} s . t . 〈 {w}_{ref} , {q}_{kf} 〉 \\ {H}_{kr} {q}_{kf} & else\end{matrix} \qquad ( 6 )$$

where M_{cr} is a matching point set between the current frame and the reference frame, Hₖᵣ is a homography matrix between the key frame and the historical reference image, in a case that a feature point w_{ref} matched with q_{kf} exists in the reference frame, it is directly used, otherwise w_{ref} is projected through the homography matrix. Thus, after a group of matching points M_{cr} between the current frame and the reference frame are established, the matching points can be directly used for estimating the homography matrix H_{cr} between the current frame and the reference frame.

Specifically, the step of performing feature descriptor replacement adopted in step 5 is specifically described as follows:

for in-situ sensing at the mobile terminal in pursuit of convenience and universality, the method may have certain robustness for change of ambient illumination. When ambient light changes slightly, even though the historical reference image and the current image provide the same feature point, descriptors thereof are hardly kept highly consistent due to illumination change. In order to ensure speed, the robustness of the in-situ sensing method for illumination is relatively improved through a simple and effective method (rather than a 3D way), and feature descriptor replacement is adopted. Specifically, when certain conditions are met, descriptors of feature points corresponding to the historical reference image are replaced with descriptors at the current moment. Thus, subsequent image feature matching is better facilitated due to consistent illumination at the current moment. The letter f represents an ORB feature point consisting of a 2D coordinate p and a descriptor d. In a case that a feature point f_{ref}=(p_{ref}, d_{ref}) at a historical reference moment is matched five or more times, a feature d_{cur} of a feature point f_{cur}=(p_{cur}, d_{cur}) corresponding to the current image is adopted as a candidate replacement descriptor. In a case that after a next image I_{cur}+1 is added, a feature point is successfully matched to the feature and becomes a key set interior point, the descriptor at the reference moment is replaced with the candidate replacement descriptor, that is r_{ref}=(p_{ref}, d_{cur})., where p_{ref} represents coordinates of the feature point of the reference image, d_{cur} represents the feature descriptor of the current image, f_{cur} represents the feature point of the current image, p_{cur} represents coordinates of the feature point of the current image, d_{ref} represents the feature descriptor of the reference image, f_{ref} represents the feature point of the reference image, and r_{ref} represents the coordinates of the feature point of the replaced image.

The method of the present invention is validated for feasibility below with reference to a specific example, and the detailed description is given as follows:
firstly, in the aspect of the verification for the in-situ sensing precision of a camera, an in-situ sensing strategy driven by key frames and a navigation vector is adopted, and a proposed ACR_Mobile method has higher repositioning efficiency and accuracy in 11 experimental scenarios through multiple rounds of experimental verification on a mobile terminal platform without the assistance of a mechanical cradle head. Compared with a linear interpolation method, ACR_Mobile provides definite motion direction guidance, such that effective alignment can be achieved without subjective judgment of a user. Compared with an H-CR method, ACR_Mobile not only has higher response speed and higher robustness, but also significantly improves the operation efficiency of the user through clear and visualized guidance information. In terms of a change trend of an AFD value, ACR_Mobile has higher decrease speed during repositioning, further verifying its capacity for high-quality real time guidance during actual application, and it has good application feasibility and promotion potential.

In the aspect of the verification for system deployment and resource consumption, the in-situ sensing method is deployed at a mobile terminal. It is shown through experiments that on a common Android device (8G memory, Snapdragon platform), the average time for locating the end side is less than 1 second, and the whole process is completed within 5-10 seconds, thereby supporting rapid on-site inspection and large-scale deployment.

In conclusion, the in-situ sensing method for the high-value object oriented to the mobile terminal provided by the present invention has high feasibility in technical logic, engineering implementation, performance and deployment efficiency, has excellent results in actual tests, and has good application and promotion prospects.

### SUMMARY AND STATEMENT

As shown in Table 1, Table 1 shows comparison results of the method in the present invention (ACR_Mobile) and an existing optimal method in in-situ sensing precision (AFD value) of a camera at a mobile terminal.

TABLE 1

| | ACR_Mobile | | H-CR | | Linear interpolation method | |
|---|---|---|---|---|---|---|
| Scenario | AFD | Time (s) | AFD | Time (s) | AFD | Time (s) |
| Cartoon | 2.3895 | 57.8 | 5.9609 | 88.0 | 23.246 | 120 |
| Gallery 1 | 1.7271 | 64.6 | 2.7716 | 80.8 | 13.116 | 95.3 |
| Gallery 2 | 2.1873 | 74.7 | 1.8672 | 115.9 | 16.277 | 106.3 |
| Building | 2.4654 | 87.4 | 4.8898 | 99.7 | 21.295 | 93.4 |
| Mural | 2.2338 | 71.1 | 5.5757 | 98.6 | 7.4881 | 99.6 |
| Attic | 2.4326 | 33.4 | 7.5662 | 57.2 | 10.570 | 41.6 |
| Automobile | 2.6941 | 59.9 | 3.1121 | 72.8 | 19.6056 | 88.4 |
| River | 1.4262 | 75.2 | 10.4781 | 100.2 | 10.4168 | 95.2 |
| Flower 1 | 4.0976 | 72.9 | 3.7423 | 86.7 | 12.9869 | 88.7 |
| Flower 2 | 2.4172 | 84.0 | 5.2454 | 122.1 | 11.8394 | 86.5 |
| Door and window | 3.6944 | 40.8 | 4.5733 | 67.5 | 24.8703 | 84.4 |

Various embodiments in this specification are described progressively, identical and similar parts of various components can be referred to each other, and each embodiment focuses on the differences from other embodiments. Especially, since system embodiments are basically similar to method embodiments, they are simply described, and relevant parts thereof refer to the description of the method embodiments. The system embodiments described above are merely illustrative, where units and modules described as separating components may be or may not be physically separated. In addition, part or all of units and modules may be selected according to actual requirements to achieve the objectives of the solutions in the embodiments.

Those ordinarily skilled in the art can understand and implement the embodiments without involving inventive efforts.

The above descriptions are merely preferred embodiments of the present invention, however, the present invention is not limited to them. Any change easily made by those ordinarily skilled in the art and multiple improvements and modifications made on the premise of not departing from the principle of the present invention should fall within the scope of protection of the present invention.

1. An active in-situ sensing method for a high-value object oriented to a mobile terminal, comprising:
capturing to obtain image frames in real time according to a reference image;
extracting Oriented FAST and Rotated BRIEF(ORB) feature points and feature descriptors from two image frames, performing multi-feature fusion matching to obtain reliable matching pairs meeting a projection constraint, and estimating a homography matrix between the two image frames;
generating a navigation frame according to the homography matrix, and obtaining a navigation vector from the navigation frame, where the navigation frame includes a reference frame and a guidance frame;
adjusting a camera pose according to the navigation vector by using the mobile terminal, thereby enabling the reference frame to overlap with the guidance frame to form an adjustment object;
locating the navigation frame by adjusting the camera pose, where a visual region meets requirements in a case that the reference frame coincides with the guidance frame as for key frames, thereby completing in-situ sensing; and
outputting an in-situ sensed image.

2. The active in-situ sensing method for a high-value object oriented to a mobile terminal according to claim 1, wherein the navigation vector further includes a navigation direction, the navigation direction includes left-and-right motion, up-and-down motion, front-and-back motion, left-and-right rotation, up-and-down rotation, and clockwise-and-anticlockwise rotation.

3. The active in-situ sensing method for a high-value object oriented to a mobile terminal according to claim 1, wherein the step of performing the multi-feature fusion matching on the two image frames to obtain the reliable matching pairs meeting the projection constraint further includes:
as for the ORB feature points and the feature descriptors extracted from a current frame of image, extracting key points and binary descriptors of two images by using an ORB algorithm in parallel, performing initial matching through a Hamming distance, estimating the homography matrix between the two images through a Random Sample Consensus algorithm, eliminating geometrically-inconsistent mismatching points, and finally reserving the reliable matching pairs meeting the projection constraint.

4. The active in-situ sensing method for a high-value object oriented to a mobile terminal according to claim 1, wherein the step of locating the navigation frame by adjusting the camera pose further includes:
adding a current frame to a key frame set in a case that a current moment exists more than 5 consecutive frames and a distance between each frame and a best key frame is greater than 15 pixels, or the number of matching points for the current frame exceeds a threshold.

5. The active in-situ sensing method for a high-value object oriented to a mobile terminal according to claim 4, wherein the step of locating the navigation frame by adjusting the camera pose, where the visual region meets requirements in a case that the reference frame overlaps with the guidance frame as for the key frames, thereby completing the in-situ sensing further includes: performing key frame update and feature descriptor replacement.

6. The active in-situ sensing method for a high-value object oriented to a mobile terminal according to claim 5, wherein the step of performing the key frame update further includes a key frame update strategy, after generating corresponding navigation information for the current frame, determining whether the current frame is robust enough to become a new key frame, and updating the best key frame and a worst key frame.

7. The active in-situ sensing method for a high-value object oriented to a mobile terminal according to claim 5, wherein the step of performing the feature descriptor replacement further includes:
if a feature point f_{ref}=(p_{ref}, d_{ref}) at a historical reference moment is matched five or more times, adopting a feature of the corresponding feature point in a current image as a candidate replacement descriptor d_{cur};
if after an image is added to the key frame set, a feature point is successfully matched to a feature of the image and becomes an interior point in the key frame set, replacing a descriptor at the historical reference moment with the candidate replacement descriptor, indicated as r_{ref}=(p_{ref}, d_{cur}), and skipping to the multi-feature fusion matching;
where f_{ref} represents the feature point of the reference image, p_{ref} represents coordinates of the feature point of the reference image, d_{ref} represents a feature descriptor of the reference image, and r_{ref} represents coordinates of the feature point of the replaced image.

8. The active in-situ sensing method for a high-value object oriented to a mobile terminal according to claim 1, wherein the navigation vector allows for visual representation of the navigation information.
